(19) United States
(12) Patent Application Publication
(10) Pub. No.: US 2022/0108460 A1
(43) Pub. Date: Apr. 7, 2022

(54) SYSTEM AND METHOD FOR USE IN GEO-SPATIAL REGISTRATION

(71) Applicant: AGENT VIDEO INTELLIGENCE LTD., Rosh HaAyin (IL)

(72) Inventor: ZVIKA ASHANI, Ganey Tikva (IL)

(21) Appl. No.: 17/310,422

(22) PCT Filed: Feb. 6, 2020
(86) PCT No.: PCT/IL2020/050148

§ 371 Date: Aug. 2, 2021

(30) Foreign Application Priority Data
Feb. 12, 2019 (IL) 264797

(51) Int. Cl. G06T 7/33; G06T 7/32; G06T 7/80; H04N 7/18

(52) U.S. Cl. CPC G06T 7/33; G06T 7/32; G06T 7/80; G06T 2207/30232; G06T 2207/30204; G06T 2207/10016; G06T 2207/20092; H04N 7/181

(57) ABSTRACT

A method for geo-spatial registration of one of more cameras. The method comprises: providing cameras located for collecting image data of a region; providing operators carrying positioning devices, moving in selected paths in the region. The positioning devices generating position data sets of said selected paths. The operators carry selected visible markings. Marking data of the selected visible markings is used. Providing input data comprising the image data collected by the cameras and position data sets, and processing the data. The processing comprises using marking data for processing the image data and identifying appearance of markings in the image data. Generating image path data indicative of paths of the operators in the image data, and processing the path data in accordance position data set for determining correlation between path of the operators and the position data set. Using the correlation determining registration mapping for the cameras in the region.

### TECHNOLOGICAL FIELD

The present invention relates to systems and techniques for geo-spatial registration. The present technique is specifically relevant to registration of data input from one or more video cameras.

### BACKGROUND

Video cameras are used in various industries for monitoring and surveillance of selected regions. Generally, the video cameras are mounted in selected locations where each camera has a field of view defining its coverage zone. Image data sequences are being collected by one or more video cameras and processed for monitoring the coverage zones.

Both automated and manual processing of the collected image data, generally requires certain known correspondence between different locations or pixel maps in the image data and respective locations in the actual space of the coverage zone. This correspondence is known as geo-spatial registration, linking the collected image data with real locations on the region viewed by the video cameras.

In U.S. Pat. No. 7,949,150, a video sequence of a field of view within an environment is received. Targets are detected in the video sequence. Target geo-positional information is received. Correspondences between the targets detected in the video sequence and the target geo-positional information are determined and used to calibrate the camera and to geo-register a field of view of the camera.

### GENERAL DESCRIPTION

The invention relates to techniques for determining registration function for an arrangement of one or more imaging units in a region of interest. Generally, after employing one or more camera units is selected positions for collecting image data streams of a region of interest, certain registration of the image data with respect to actual physical locations is needed to allow proper monitoring of the region of interest. To this end the present technique utilizes monitoring movement of one or more operators within the region of interest. More specifically, the present technique utilizes collection of image data from the one or more camera units and position data provided by the one or more operators, and monitoring correlation between appearances of the operators in the image data and corresponding location data thereof.

According to the present technique, the one or more operators are directed to move around within the region of interest while collecting location data (e.g. using GPS system). The operators are further provided with selected visible markings that can be identified by image data processing, for identifying the location of each operator in image data collected by the one or more camera units.

Accordingly, the present technique utilizes computer readable medium carrying software for video processing. The software, when executed by a computer system causes the computer to perform operations comprising: receiving input image data comprising image data streams collected by one or more camera units from a region of interest, receiving location data comprising data on location of one or more operators directed to move around in the region of interest, receive marking data indicative of preselected visual marking of the one or more operators, and using the marking data for processing the input image data and location data, to thereby determine correlation between locations of the one or more operators and their respective appearance in the input image data.

The present technique enables geo-spatial registration of video camera feed, while solving the issue of crowded region of interest and operators' overlap in the image data. More specifically, the present technique allows identification of the one or more operators in the input image data over any number of foreground elements. For example, when the region of interest is a busy street, the present technique allows geo-spatial registration to be performed in broad daylight without the need to reduce traffic in the region of interest.

More specifically, by providing each of the one or more operators, e.g. human operators walking around or vehicles moving, with selected markings that are visible in the image data, processing of the image data is generally relatively simple and requires identification of specific pre-provided patterns. For example, operators walking in the region of interest may be provided with vest and/or hat having selected color pattern, which may be specific for each operator. In some configurations the marking may include Infrared light (e.g. led) configured to provide defined illumination pattern. The marking is selected to simplify image processing for identifying location or the respective operators in the image data and is typically assigned to the operator identity.

Thus, according to a broad aspect, the present invention provides:

1. A method for geo-spatial registration of one of more camera units, the method comprising:

providing one or more camera units located for collecting one or more image data sequences of a region of interest;

providing one or more operators, each carrying one or more positioning devices, moving in selected paths in the region of interest, wherein said one or more positioning devices generating corresponding position data sets indicative of said selected paths, and said one or more operators are provided with one or more selected visible markings;

providing marking data on the one or more selected visible markings;

providing input data comprising one or more image data sequences collected by said one or more camera units and one or more position data sets;

using one or more computer processor and processing said input data, said processing comprises using said marking data for processing said one or more image data sequences for identifying appearance of said one or more markings in said one or more image data sequences, generating image path data indicative of one or more paths of said one or more operators in said image data sequences, and processing said image path data in accordance with said one or more position data set for determining correlation data between path of said one or more operators in the image data sequences and corresponding position data set; and using said correlation data for determining registration mapping for said one or more camera units in said region of interest.

2. The method described in 1, wherein the one or more visible markings are selected to allow distinguishing said one or more operators from general foreground activity in said region of interest. For example, marking may include clothing or headwear of bright color or color pattern, colored marking on rooftop of a vehicle etc.

3. The method of 1 or 2, wherein the one or more visible markings may be different markings for each of the one or more operators, thereby enabling distinguishing between operators.

4. The method in 1 to 3, wherein said one or more visible markings comprise one or more of: specially colored head ware, specially colored clothing, specially colored rooftop element, flag, light source having selected illumination pattern.

5. The method described in 1 to 4, wherein the one or more visible markings may comprise radiation emitting device configured for emitting optical radiation in wavelength visible to said one or more camera units, such as light emitting device (e.g. LED).

6. The radiation emitting device in 5. may be configured for emitting radiation having selected time pattern, said selected time patterns provides marking data of the radiation emitting device.

7. The method in 1 to 6, wherein the input data may comprise time data indicative of time of collection of said one or more image data sequences collected by said one or more camera units and one or more position data sets. The use of time data, or time stamps, associated with both position data and image frames simplifies processing for determining correlation and enables generating one or more registration anchors where position of an operator is known both in the image data and by position data.

According to one other broad aspect, the present invention provides:

8. A method for use in geo-spatial registration, the method comprising: providing video data comprising one or more image data sequences collected by one or more camera units from a region of interest, provide position data comprising one or more positions data sets indicative of path made by one or more operators in said region of interest, providing marking data indicative of visible markings of said one or more operators, processing said video data in accordance with said marking data for determining at least one image path indicative of path of at least one operator as observed in the one or more image data sequences, processing said at least one image path in accordance with position data associated with said at least one operator and determining correlation between the image path and position data, using said correlation for determining registration map for said one or more camera units.

In some embodiments, the position data and video data may comprise time stamps indicative of time of capturing a frame and time of determining position of on operator, said processing may comprise determining location in frame and position in the region of interest having common time stamp for determining a registration anchor point.

According to yet another broad aspect, the present invention provides a computer readable medium (e.g. non-transitory computer readable medium) comprising software data, which when executed by a computer system causes the computer to perform operations comprising:
receiving one or more image data sequences collected by one or more camera units from a region of interest; receiving one or more position data sets indicative of path of one or more operators in said region of interest; obtaining marking data indicative of visual marking associated with said one or more operators; processing the one or more image data sequences in accordance with said marking data for identifying appearances of said one or more operators in at least one image data sequence, using said one or more position data and determining correlation between appearances of said one or more operators in at least one image data sequence and corresponding position data, and determining registration data for said one or more camera units and said region of interest.

According to some embodiments, the processor/computer operations may comprise provide indication of one or more camera units associated with selected camera system and requesting user input on selection of camera unit for registration.

According to some embodiments, the processor/computer operations may comprise obtaining live feed of image frames from a selected camera unit at selected frame rate.

According to some embodiments, the processor/computer operations may comprise being responsive to user-initiated input comprising indication of marking location within a received image frame.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates schematically a system for determining registration data for one or more camera unit according to some embodiments of the present invention;

FIG. 2 shows in a way of a flow diagram a technique for determining registration data for one or more camera unit according to some embodiments of the present invention;

FIG. 3 illustrates the present technique and exemplifies operation according to some embodiments of the present invention; and

FIG. 4 illustrates a technique for operating registration within using a computer system according to some embodiments of the invention.

### DETAILED DESCRIPTION OF EMBODIMENTS

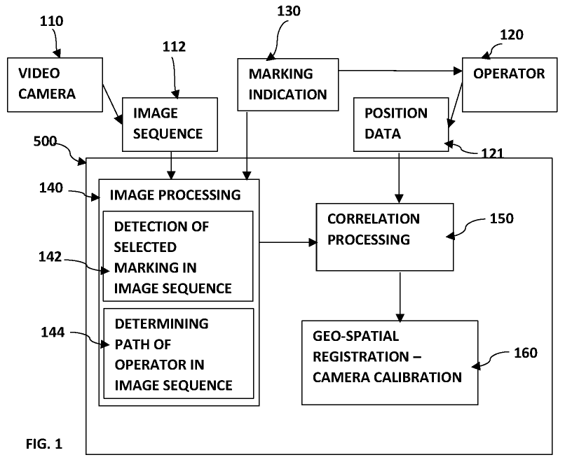

As indicated above, the present invention provides a technique for geo-spatial registration of one or more camera units positioned for collecting image data sequences (e.g. video data) from a region of interest. Reference is made to FIG. 1 schematically illustrating a technique for use in registration according to some embodiments of the present invention. As shown, the present technique utilizes one or more image data sequences 112 collected by one or more camera units 110 from a region of interest. The purpose of the registration process is generating a transformation function that allows mapping the position of each point in the image data to an actual location in the world. Typically, some locations in the region of interest may be covered by two or more camera units, while some other may be covered by only a single camera unit. Also, in some configurations, certain locations in the region of interest might be blind spots that are not covered by any of the camera units 110. Such registration or mapping data enables both automatic computer system 500 and human operated system to provide effective indication on location of an activity identified from the image data. This enables the system to better define various alerts and to properly provide indication directing other parts of the system, or external systems/operators to the alert.

The registration process may generally be performed after installation of the one or more camera units and suitable system, or periodically for proper calibration. According to the present technique, a one or more operators are directed to move around in the region of interest while carrying and operating corresponding positioning devices 120. The positioning device(s) collects position data 121 of the operator(s) when moving in the region of interest and transmits the position data 121 to the processing system 500 (e.g. server, computer system, etc.) for use in registration. In addition to the position information the data generally also includes operator ID data and time stamps associated with position data pieces.

The positioning device may be any type of positioning device capable of determining current position of the operator within the region of interest and providing the position data to the computer system 500. The positioning device may transmit the position data online or store the position data and allow offline access thereto. In some configurations, the positioning device may for example be in the form of global positioning system (GPS) device. In some embodiments the positioning device may be a transmitter beacon linked to selected positioning system that is capable of determining position of the beacon and provide position data to the computer system 500.

In addition to the positioning devices, the operators are provided, according to the present technique, with selected marking indications 130. The marking indications 130 include one or more elements that provide clear indication to operator location and identity and can be seen in the image data. For example, the marking indication 130 may include a hat, coat or vest with selected color or color pattern that is distinguishable from the surroundings. In some other examples, the marking indication may include one or more light sources, e.g. LED light source, configured for generating selected illumination pattern to be visible in image data. The marking indications may also be selected paint or light unit mounted on a vehicle, e.g. on top of a vehicle.

The present technique utilizes one or more computer systems (e.g. server system or any other computer system) for receiving and processing the collected data and generating geo-spatial registration mapping for the one or more camera units in the region of interest. The processing includes receiving one or more of the image data sequences 112 from the camera units (or from a storage device) and receiving data on the marking indication 130. An initial image processing 140 includes processing of the one or more image data sequences for detection of the marking indications in one or more frames 142. Using the one or more frames in which the marking indications are detected, the processing may include generating data indicative of path of the corresponding one or more operators in the image data sequences 144. The processing further utilizes position data 121 received from corresponding positioning devices 120 on the one or more operators, for determining correlation 150 between path of the operators in the image data sequences and the relevant position data. The correlation between path in the image data and position data of the operators is used for generating a registration mapping 160 indicating the relation between pixels in the image data and geo-spatial location in the region of interest.

The present technique utilizes selected marking indications 130 associated with the one or more operators. The marking indications provides for simplifying image processing for identifying location of the one or more operators in the image data, as well as for allowing operation of the registration calibration technique described herein in non-sterile region of interest. For example, when the region of interest includes one or more streets, at certain times the region of interest may be crowded with people and/or vehicles. Proper marking indications of the one or more operators reduces complexity of image processing and allows the present technique to identify the location of the one or more operators in the image data over various other foreground elements. The computer system (e.g. server) operating for processing the one or more image data sequences and positioning data also receives marking data enabling to simplify detection of the operators' location in the image data.

Generally, the marking indications 130 may be similar between the one or more operators, providing identifiable indication of the operators' location in the image data. However, in some configuration of the present technique, the marking indication data may be paired to the one or more operators providing an individual marking indicator for each operator, different than other operators. Generally, the marking data is provided to the system and pre-stored in a dedicated memory sector in the form of data list including operator ID and corresponding marking. Such list including data on the specific marking for each operator may be generated specifically when operating the registration collection technique as described herein or be pre-prepared and stored including indication on correspondence between marking and location devices associated with the one or more operators. This may be preferable when the region of interest covered by the one or more camera units includes a large area within a common frame. In such case, the more than one operator may be visible in the frame at the same time. Accordingly, enabling the processing to distinguish between the operators based on marking thereof, may simplify processing by omitting the need for parallel processing of the image data 112 in combination with determining correlations to the position data 121.

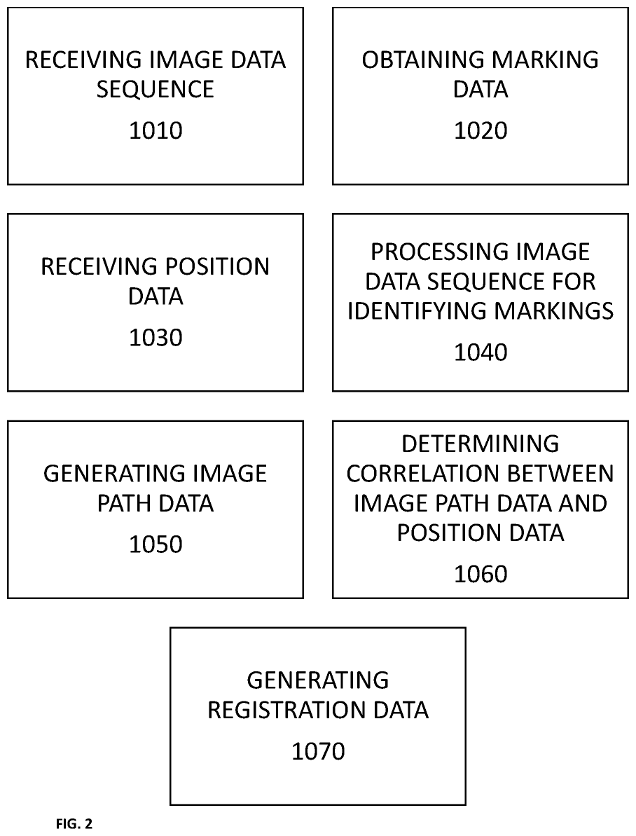

Reference is made to FIG. 2 exemplifying in a way of a block diagram, main processing actions according to some embodiments of the present technique. As indicated above, the present technique may be operated by one or more computer systems including one or more processors and memory utility in accordance with input data. As shown in FIG. 2, the one or more processors are operated by the present technique to be responsive to input data. More specifically, the one or more processors operate to receive image data sequence 1010, or plurality of image data sequences from one or more camera units. Additionally, the one or more processors operate to obtain marking data 1020, e.g. provided by one or more operators in accordance with marking indicators used and/or stored in the memory utility and for receiving position data 1030 from position devices used by the one or more operators. The computer system is further operated according to some embodiments of the present technique for processing the image data sequence in accordance with the marking data for identifying appearances of the marking indications in different frames of the image data sequence 1040. Generally, for each appearance of the marking indication, the processing may identify time stamp data (e.g. time stamp of the image frame) and pixels' coordinates (e.g. center of mass coordinates). In some configurations the processing may identify additional data elements such as camera orientation, optical parameters etc. These additional parameters may be highly relevant in system configurations where one or more of the camera units is moveable or configured to operate with varying zoom or other optical parameters.

The data indicating appearances of the marking indications in different frames is collected throughout the image data sequences and used for generating one or more image data paths 1050. Each image data path includes data indicating time and location, within the image frames, of an operator. Using the image path data and the positioning data associated with common operator ID, the processing operated for determining correlations between the image path data and the positioning data 1060. In accordance with the so-determined correlations the technique determines a registration data 1070, which may include mapping indicating different pixels in the image data and corresponding position in the region of interest. For example, the technique may utilize one or more mapping techniques such as eight-point algorithm, or other known techniques for calculating and determining the registration mapping.

Generally, determining correlation 1060 between the image path data and the positioning data may be associated with identifying location data having time stamp that is similar to time stamp of certain appearance in the image data. Thus, the relevant location in the image data (i.e. relevant pixel region, or pixel region with the corresponding camera parameters) may be determined in accordance with time stamps of the positioning data and image path data. However, in case on limited on no synchronization between the positioning data time stamp and the image data time stamp, the present technique may include additional correlation detection techniques.

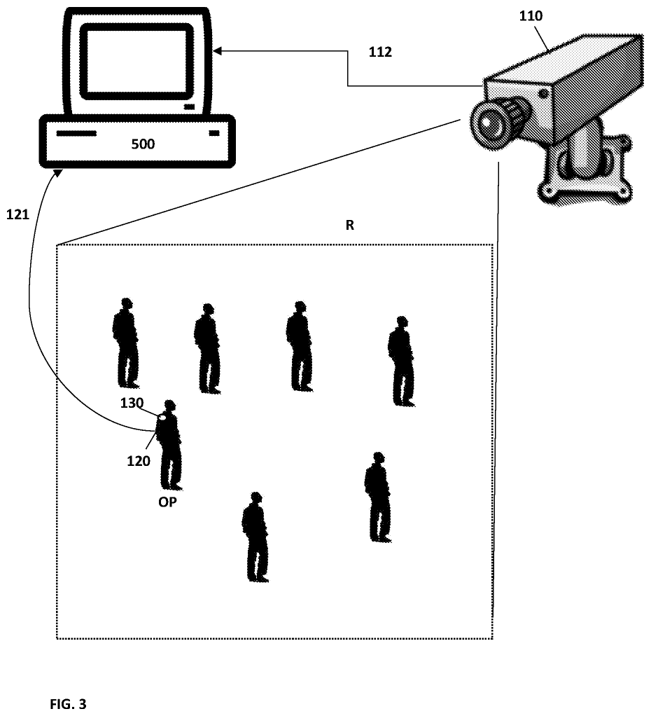

Reference is made to FIG. 3 illustrating operation of the present technique. As shown, camera unit 110 is positioned for collecting image data from a region of interest R, and for transmitting the collected image data to computer system 500 for processing. To determine registration data, one or more operators OP are directed to move around in the region of interest R carrying positioning device 120 and selected visible marking 130. Data on the marking carried by the operators, and corresponding positioning device ID is provided to the computer system and stored in selected memory sectors thereof. The computer system 500 utilizes image data 112 received from the camera unit 110 and marking data 130 for determining location of the operator OP in the image data. As exemplified in FIG. 3, the use of marking data enables simple recognition of the operator OP with respect to other elements in the region of interest. This allows the present technique to perform registration at any time (e.g. rush hour) and not requiring low activity time. The computer system 500 may operate in real-time or at a later time (offline processing) in accordance with the above described technique for determining registration data. The registration data may typically include a data sheet, or matrix, indicating correspondence between pixels in the image data and corresponding locations in the region of interest R. The registration data is later stored in the memory utility of the computer system 500, or any other computing system used in processing of image data collected from camera unit 110, for determining alerts and selecting operations and response to such alerts by the system or by operators thereof.

In this connection the present technique may utilize various implementations associated with selection of the marking indication and/or the position device and communication between the position devices and the computer system operating for registration. For example, the one or more operators may be provided with clothing and/or headwear having specifically selected marking (e.g. color pattern vest and hat) and provided with mobile communication device including GPS unit and network communication (e.g. smartphone). The communication device is pre-installed with a dedicated software product (smartphone app) configured for collecting position data and receiving, through the network communication, image data generated by one or more camera units for which registration is to be performed. The mobile device, and its processor, is operated for processing selected frames received from the camera unit for identifying location of the operator within the frame. The processing is generally based on locating the selected marking on the operator clothing and determining position of the operator as provided by the GPS unit at the same time of the frame. Upon collecting selected number of locations within covering region of the camera unit, a complete registration mapping is determined and sent to a server for later use.

According to some embodiments, the software product may include communication data allowing communication (preferably encrypted communication) with one or more camera units using selected communication protocols. The software product may also include certain user interface allowing the operator to control selected parameters such as selection of camera unit for registrations, providing data on making indication (based on the colored pattern of the clothing) etc.

In some configurations, the technique may provide live feed of image data collected by the one or more selected camera units. Using the live feed of image data, the operator may verify registration process as well as correct camera selection. In some configurations, the processor may be responsive to operator input for determining location of the operator within the image frame.

It should be noted that the software product as described herein may utilize local processing as well as remote processing, e.g. by a server, for determining location of the operator within the frame (by locating appearance of the marking indication in the frame) as well as for assigning position data to frame pixel (and frame data such as zoom level, camera orientation etc.) for generating registration anchor as a point for which image pixel and position data are known and correlated. Upon collection of sufficient number of registration anchors for determining registration mapping, the processor may operate to provide indication to the operator for either completing the task or moving to next camera unit.

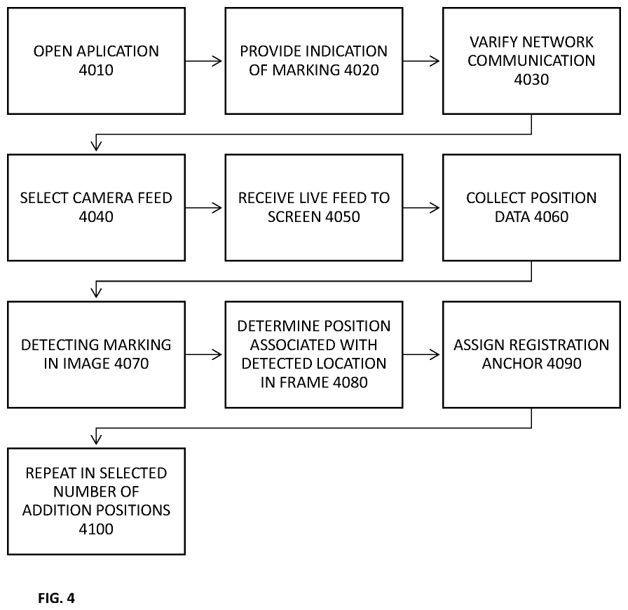

Reference is made to FIG. 4 illustrating the above described technique. As shown, upon startup of the software product 4010 using a computer device (e.g. hand-held computer device), the operator receives indication to use selected marking or to provide data on marking used 4020. The user may receive indication to enable position data and connect to suitable communication network and verify communication 4030. When communication is established, the processor enables selection of camera feed, choosing a camera for registration 4040, and to receive live, or partially live feed to the screen 4050. Generally, at any stage of operation, the device is operated for collecting position data 4060 and sorting position data is selected memory sector. The processor is operated for monitoring the image data and detect the selected marking in the image frame 4070. Such detection may be assisted by operator indicating the marking on the frame in some configurations. Once the marking is identified, the processor operates for determining position data at the corresponding time 4080 (e.g. at the same time) and assign a registration anchor 4090. The process may be repeated for selected number of registration anchors 4100 depending of area of the field of view and desired accuracy of registration.

Thus, the present invention provides a technique, typically computer operated technique, for use in determining registration data for one or more camera units. The present technique simplified processing and allows operating for registration calibration at any given time while avoiding interference with general activity in the region of interest.

1. A method for geo-spatial registration of one of more camera units, the method comprising:
(a) providing one or more camera units located for collecting one or more image data sequences of a region of interest;
(b) providing one or more operators, each carrying one or more positioning devices, moving in selected paths in the region of interest, wherein said one or more positioning devices generating corresponding position data sets indicative of said selected paths, and said one or more operators are provided with one or more selected visible markings;
(c) providing marking data on the one or more selected visible markings;
(d) providing input data comprising one or more image data sequences collected by said one or more camera units and one or more position data sets;
(e) using one or more computer processor and processing said input data, said processing comprises using said marking data for processing said one or more image data sequences for identifying appearance of said one or more markings in said one or more image data sequences, generating image path data indicative of one or more paths of said one or more operators in said image data sequences, and processing said image path data in accordance with said one or more position data set for determining correlation data between path of said one or more operators in the image data sequences and corresponding position data set; and
(f) using said correlation data for determining registration mapping for said one or more camera units in said region of interest.

2. The method of claim 1, wherein said one or more visible markings being selected to allow distinguishing said one or more operators from general foreground activity in said region of interest.

3. The method of claim 1, wherein said one or more visible markings comprise different markings for each of the one or more operators, thereby enabling distinguishing between operators.

4. The method of claim 1, wherein said one or more visible markings comprise one or more of: specially colored head ware, specially colored clothing, specially colored rooftop element, flag, light source having selected illumination pattern.

5. The methods of claim 1, wherein said one or more visible markings comprise radiation emitting device configured for emitting optical radiation in wavelength visible to said one or more camera units.

6. The method of claim 5, wherein said radiation emitting device is configured for emitting radiation having selected time pattern, said selected time patterns provides marking data of the radiation emitting device.

7. The method of claim 1, wherein said input data comprise time data indicative of time of collection of said one or more image data sequences collected by said one or more camera units and one or more position data sets.

8. A method for use in geo-spatial registration, the method comprising: providing video data comprising one or more image data sequences collected by one or more camera units from a region of interest, provided position data comprising one or more positions data sets indicative of path made by one or more operators in said region of interest, providing marking data indicative of visible markings of said one or more operators, processing said video data in accordance with said marking data for determining at least one image path indicative of path of at least one operator as observed in the one or more image data sequences, processing said at least one image path in accordance with position data associated with said at least one operator and determining correlation between the image path and position data, using said correlation for determining registration map for said one or more camera units.

9. A non-transitory computer readable medium comprising software data, which when executed by a computer system causes the computer to perform operations comprising:
receiving one or more image data sequences collected by one or more camera units from a region of interest; receiving one or more position data sets indicative of path of one or more operators in said region of interest; obtaining marking data indicative of visual marking associated with said one or more operators;
processing the one or more image data sequences in accordance with said marking data for identifying appearances of said one or more operators in at least one image data sequence, using said one or more position data and determining correlation between appearances of said one or more operators in at least one image data sequence and corresponding position data, and determining registration data for said one or more camera units and said region of interest.

10. The non-transitory computer readable medium comprising software data of claim 9, where said operations comprise provide indication of one or more camera units associated with selected camera system and requesting user input on selection of camera unit for registration.

11. The non-transitory computer readable medium comprising software data of claim 9, where said operations comprise obtaining live feed of image frames from a selected camera unit at selected frame rate.

12. The non-transitory computer readable medium comprising software data of claim 9, wherein said operations comprise being responsive to user-initiated input comprising indication of marking location within a received image frame.
